(19) United States
(12) Patent Application Publication
(10) Pub. No.: US 2026/0072192 A1
(43) Pub. Date: Mar. 12, 2026

(54) VISUAL DIFFERENCE SEISMIC IMAGE

(71) Applicant: Schlumberger Technology Corporation, Sugar Land, TX (US)

(72) Inventors: William Sanger, Houston, TX (US); Matteo Marrone, Milan (IT)

(21) Appl. No.: 19/316,220

(22) Filed: Sep. 2, 2025

Related U.S. Application Data
(60) Provisional application No. 63/693,774, filed on Sep. 12, 2024.

(51) Int. Cl. G01V 1/36; G01V 1/28; G01V 1/30

(52) U.S. Cl. CPC G01V 1/366; G01V 1/282; G01V 1/301; G01V 1/303

(57) ABSTRACT

A method for displaying seismic images includes receiving a first seismic image and a second seismic image, partitioning the first seismic image into a first windowed image, and the second seismic image into a second windowed image, generating embeddings based at least in part on the first and second windowed images using an encoder comprising a neural network, determining differences between in the first and second seismic images based at least in part on the embeddings, generating similarity tiles representing at least some of the differences, generating output seismic images by interpolating the similarity tiles using a decoder comprising a neural network, and displaying perceptual differences in the first and second seismic images generated based at least in part on the output seismic images.

### CROSS-REFERENCE TO RELATED APPLICATIONS

This application claims priority to U.S. Provisional Application having Ser. No. 63/693,774 which was filed on Sep. 12, 2024 and is incorporated by reference herein it its entirety.

### BACKGROUND

Interpretation of seismic images is employed in a wide variety of industries to determine attributes of a subsurface domain based on seismic waves that propagate through the subsurface domain. The seismic images are generated through a variety of processing techniques from the waveform data.

In some cases, seismic images taken from a single volume may be compared, e.g., to determine changes in the images. Such images may be acquired at different points in the seismic interpretation process and thus may differ based on the interpretation processes applied thereto (e.g., noise attenuation). In other cases, multiple images may represent the same subsurface location at different times, e.g., before and after a certain event and/or duration but comparing these images to determine subtle differences proves challenging.

### SUMMARY

In an example, a method for displaying seismic images includes receiving a first seismic image and a second seismic image, partitioning the first seismic image into a first windowed image, and the second seismic image into a second windowed image, generating embeddings based at least in part on the first and second windowed images using an encoder comprising a neural network, determining differences between in the first and second seismic images based at least in part on the embeddings, generating similarity tiles representing at least some of the differences, generating output seismic images by interpolating the similarity tiles using a decoder comprising a neural network, and displaying perceptual differences in the first and second seismic images generated based at least in part on the output seismic images.

In an example, a computing system includes one or more processors, and a memory system having one or more non-transitory computer-readable media storing instructions that, when executed by at least one of the one or more processors, cause the computing system to perform operations. The operations include receiving a first seismic image representing a subsurface region, generating a second seismic image by applying an interpretation process to the first seismic image, partitioning the first seismic image to form a first patch, and the second seismic image for form a second patch, generating embeddings based at least in part on the first and second patches using an encoder including a neural network, determining differences between in the first and second seismic images based at least in part on the embeddings, generating similarity tiles representing at least some of the differences, generating output seismic images by interpolating the similarity tiles using a decoder comprising a neural network, and displaying perceptual differences in the first and second seismic images generated based at least in part on the output seismic images.

In an example, a non-transitory computer-readable medium stores instructions that, when executed by one or more processors of a computing system, cause the computing system to perform operations. The operations may include receiving a first seismic image and a second seismic image, the first and second seismic images representing a same subsurface region, selecting a first two-dimensional cross-section from the first seismic image, and a second two-dimensional cross-section from the second seismic images, partitioning the first and second two dimensional cross-sections into a first windowed image and a second windowed image, respectively, generating embeddings based at least in part on the first and second windowed images using an encoder comprising a neural network, the neural network being trained for one or more two-dimensional slices of seismic images, determining differences between in the first and second seismic images based at least in part on the embeddings, generating similarity tiles representing at least some of the differences, generating output seismic images by interpolating the similarity tiles using a decoder, and displaying perceptual differences in the first and second seismic images generated based at least in part on the output seismic images.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate examples of the present teachings and together with the description, serve to explain the principles of the present teachings. In the figures:

FIG. 1 illustrates an example of a system that includes various management components to manage various aspects of a geologic environment, according to an example.

FIG. 2 illustrates a flowchart of a method for displaying a difference between seismic images, according to an example.

FIG. 3 illustrates a conceptual view of producing an attribute that highlights areas of greatest visual difference between two co-located 3D image volumes, according to an example.

FIG. 4 illustrates a conceptual view of computation of embeddings to determine a local encoding of semantic and stylistic visual content between the two seismic image volumes, according to an example.

FIG. 5 illustrates a conceptual view of computing local (e.g., window-scale) visual differences between the two seismic image volumes, based on the differences between the encodings, according to an example.

FIG. 6 illustrates a schematic view of a computing system, according to an example.

### DETAILED DESCRIPTION

Reference will now be made in detail to examples, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the examples.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular examples and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some examples. Some operations in the processing procedures, methods, techniques, and workflows disclosed herein may be combined and/or the order of some operations may be changed.

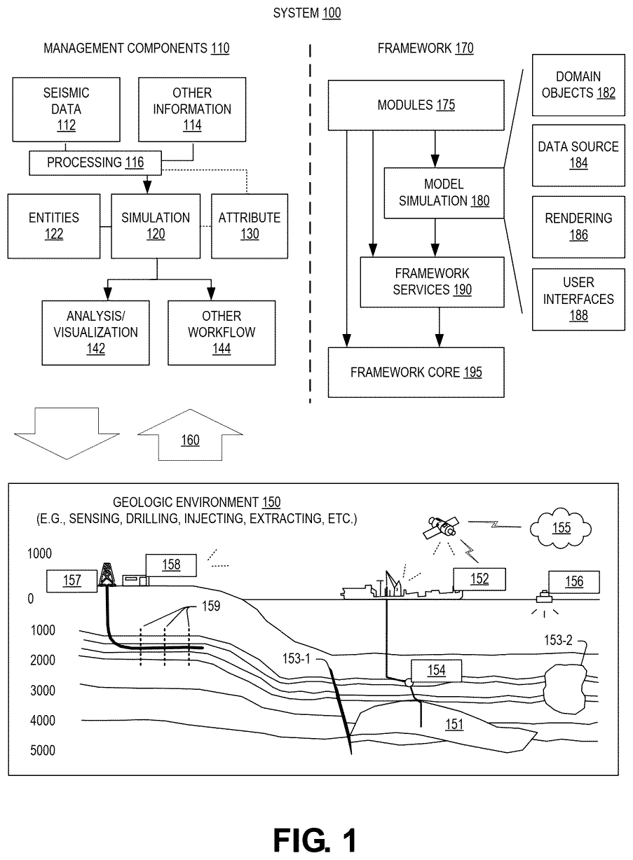

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Texas), the INTERSECT™ reservoir simulator (Schlumberger Limited, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example, the management components 110 may include features of a commercially available framework such as the PETREL® seismic to simulation software framework (Schlumberger Limited, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example, various aspects of the management components 110 may include add-ons or plug-ins that operate according to specifications of a framework environment. For example, a commercially available framework environment marketed as the OCEAN® framework environment (Schlumberger Limited, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

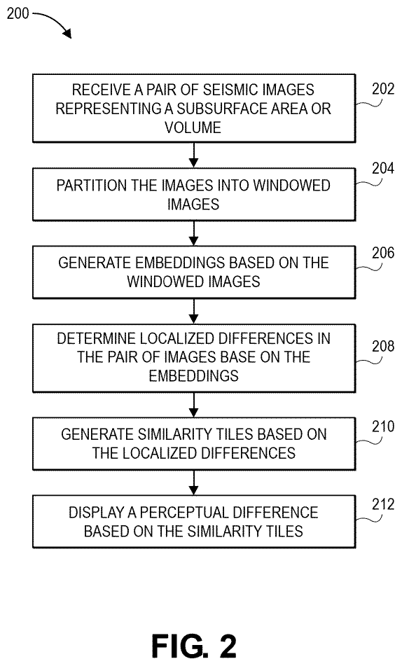

FIG. 2 illustrates a flowchart of a method for displaying a difference between seismic images, according to an example. The method 200 includes receiving first and second (e.g., a “pair” of) seismic images (2D or 3D) representing a subsurface region (e.g., an area or volume), as at 202. In the specific case that the images are 3D, the 2D images may be generated from cross-sections (slices) of the 3D input volume at intervals. For example, one dimension may be held constant, while slices are taken in the other two directions in a seismic cube.

In at least some examples, the images may represent one or more seismic attributes of the volume. The images may be taken before and after different interpretation techniques have been applied thereto. For example, one image may be representative of the subsurface region prior to noise attenuation, and another may be representative of the same subsurface region after such noise attenuation. Still others may be before and after velocity model updates, as changing the velocity model can impact the seismic model of the subsurface. In yet other embodiments, the images may be acquired before and after a seismic event or physical process is undertaken in the subsurface. Accordingly, the visual features may be different in the two images, and it may be desirable to provide a visual indication of the differences, e.g., a perceptual difference.

The method 200 includes partitioning the images into windowed images, as at 204. For example, a grid may be applied to the images, with respective grid elements providing respective windows. The grid may be any type of grid, for example, defining any size and shape of grid element, e.g., square, tetrahedral, etc. In some contexts, windowed images may also be referred to as “patches”, and the terms may be used synonymously for purposes of this disclosure.

The method 200 may include generating embeddings based on the windowed images (patches), as at 206. Generating the embeddings may be conducted using a neural network trained to encode visual seismic images (e.g., an “encoder”), creating, for example, a matrix of numbers representing semantic and/or stylistic, etc. visual content (seismic attribute features) of the images in the individual windows. The neural network may be trained for analyzing two-dimensional images (e.g., slices) and not volumes/cubes, for example; however, in other embodiments, the neural network may be configured for use directly analyzing three-dimensional structures.

The method 200 may include determining localized differences in the pair of images based on the embeddings, as at 208. In particular, the embeddings may be compared, numerically, to identify the magnitude of difference between the images in the particular locations. Such particular locations may be represented by one or any other finite number of pixels, voxels, or another discrete unit of the images. The direction of the differences may also be determined, e.g., increasing value, decreasing value, spatial direction, etc. The direction and magnitude of the differences may be used to provide perceptual differences between the images.

The method 200 may then include generating similarity tiles based on the numerical comparison of the embeddings, as at 210. Two-dimensional slides may then be determined based on the similarity tiles, e.g., through interpolation. For example, such interpolation may generate a finer output sampling than the windows. Three-dimensional images may also be prepared based on the two-dimensional slices, by aligning and interpolating the 2D images, and/or from three-dimensional embedding difference attributes through interpolation to a more finely sampled, three-dimensional grid.

The method may also include displaying a perceptual difference (e.g., the three-dimensional images generated at 210) based on the similarity tiles (e.g., via interpolating between the 2D slices, as noted above), as at 212. In some examples, the method may also include post-processing, such as normalization, smoothing, and filtering to achieve a desired level of granularity and/or reduce noise in the attribute.

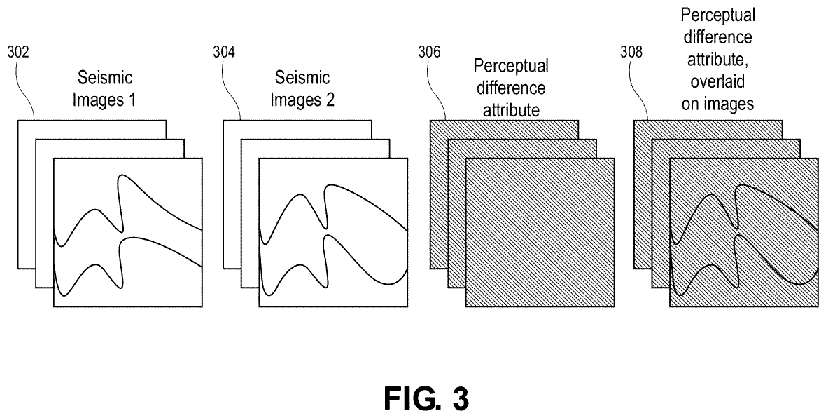

FIG. 3 illustrates a conceptual view of producing an attribute that highlights areas of greatest visual difference between two co-located 3D image volumes, according to an example. Seismic images 302 and 304 may be received, which may, for example, be two sets of slices, representing the same subsurface region (e.g., volume) at different times. As explained above, methods of the present disclosure may determine a visual difference (e.g., a perceptual difference attribute) 306 for the two sets of images 302, 304, based on embeddings. Methods of the present disclosure may also overlay the perceptual difference on the images, as shown at 308, and may display either or both of the attribute 306 and/or the overlay 308.

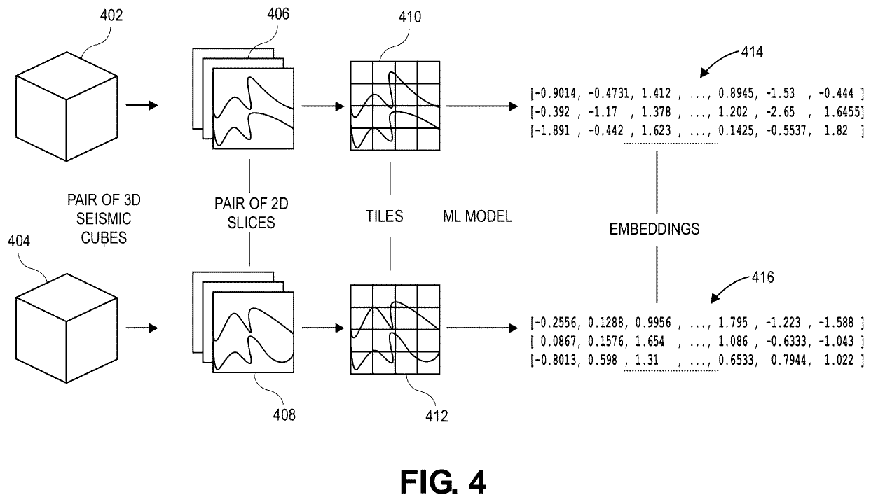

FIG. 4 illustrates a conceptual view of computing embeddings to determine a local encoding of semantic and stylistic visual content between the two seismic image volumes, according to an example. FIG. 4 may illustrate a portion of an example of the method 200 of FIG. 2. As shown, seismic cubes 402, 404 may be received, which may represent the same subsurface region (e.g., volume). The cubes 402, 404 may be converted into 2D seismic images (slices) 406, 408, respectively. In other examples, 2D images may be received initially. The slices 406, 408 may be windowed into windowed images 410, 412, respectively, which may then be fed to an encoder to generate numerical embeddings, 414, 416, respectively.

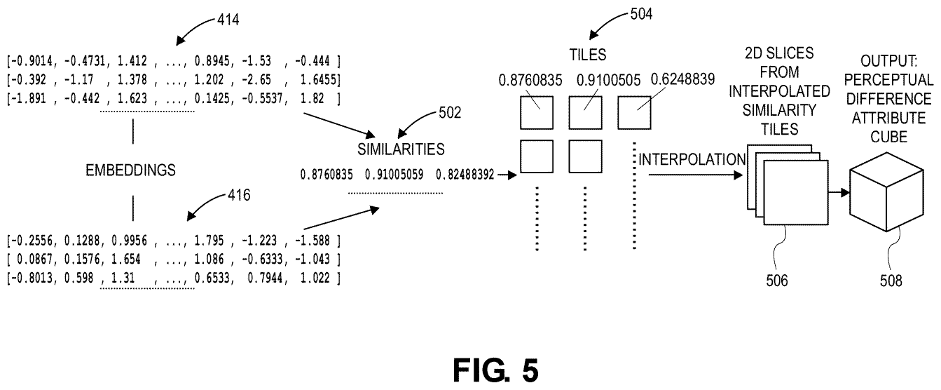

FIG. 5 illustrates a conceptual view of computing local (e.g., window-scale) visual differences between the two seismic image volumes, based on the differences between the encodings, according to an example. FIG. 5 may represent another portion of the method 200 of FIG. 2, e.g., a continuation thereof from FIG. 4. As noted in FIG. 4, the embeddings 414, 416 may be prepared, and, as shown in FIG. 5, may be compared to determine similarities 502. The similarities 502 may be numerical representations of the difference between like-elements of the embeddings 414, 416. Similarity tiles 504 may then be prepared based on the similarities 502. From the aligned tiles 504, using interpolation (e.g., decoder), 2D images 506 may be prepared, which visualize, as an attribute, the difference between the compared, seismic images 406, 408 of FIG. 4. A cube 508 may then be generated by aligning and interpolating the 2D seismic images 506.

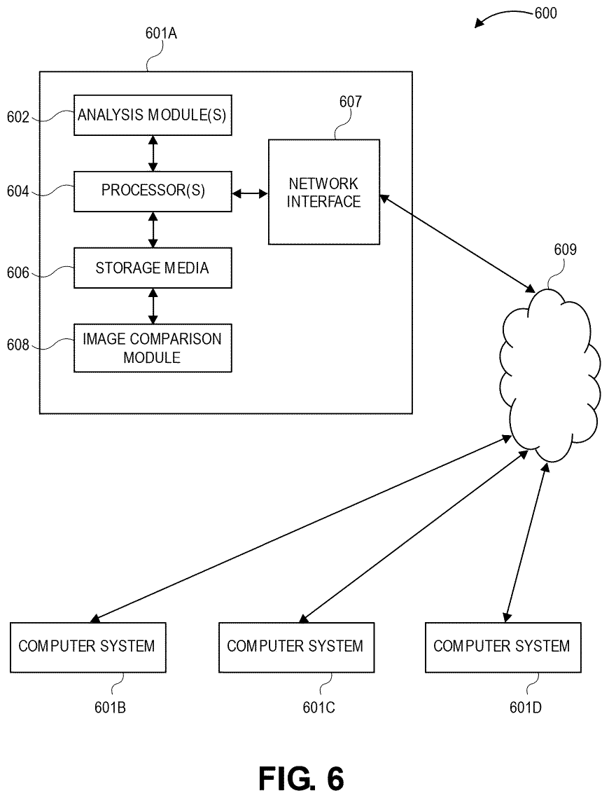

In some examples, the methods of the present disclosure may be executed by a computing system. FIG. 6 illustrates an example of such a computing system 600, in accordance with some examples. The computing system 600 may include a computer or computer system 601A, which may be an individual computer system 601A or an arrangement of distributed computer systems. The computer system 601A includes one or more analysis modules 602 that are configured to perform various tasks according to some examples, such as one or more methods disclosed herein. To perform these various tasks, the analysis module 602 executes independently, or in coordination with, one or more processors 604, which is (or are) connected to one or more storage media 606. The processor(s) 604 is (or are) also connected to a network interface 607 to allow the computer system 601A to communicate over a data network 609 with one or more additional computer systems and/or computing systems, such as 601B, 601C, and/or 601D (note that computer systems 601B, 601C and/or 601D may or may not share the same architecture as computer system 601A, and may be located in different physical locations, e.g., computer systems 601A and 601B may be located in a processing facility, while in communication with one or more computer systems such as 601C and/or 601D that are located in one or more data centers, and/or located in varying countries on different continents).

A processor may include a microprocessor, microcontroller, processor module or subsystem, programmable integrated circuit, programmable gate array, or another control or computing device.

The storage media 606 may be implemented as one or more computer-readable or machine-readable storage media. Note that while in the example of FIG. 5 storage media 606 is depicted as within computer system 601A, in some examples, storage media 606 may be distributed within and/or across multiple internal and/or external enclosures of computing system 601A and/or additional computing systems. Storage media 606 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some examples, computing system 600 contains one or more image comparison module(s) 608. In the example of computing system 600, computer system 601A includes the image comparison module 608. In some examples, a single image comparison module may be used to perform some aspects of one or more examples of the methods disclosed herein. In other examples, a plurality of image comparison modules may be used to perform some aspects of methods herein.

It should be appreciated that computing system 600 is merely one example of a computing system, and that computing system 600 may have more or fewer components than shown, may combine additional components not depicted in the example of FIG. 5, and/or computing system 600 may have a different configuration or arrangement of the components depicted in FIG. 6. The various components shown in FIG. 5 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 600, FIG. 6), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific examples. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The examples were chosen and described in order to best explain the principles of the disclosure and its practical applications, to thereby enable others skilled in the art to best utilize the disclosed examples and various examples with various modifications as are suited to the particular use contemplated.

What is claimed is:

1. A method for displaying seismic images, comprising:
receiving a first seismic image and a second seismic image;
partitioning the first seismic image into a first windowed image, and the second seismic image into a second windowed image;
generating embeddings based at least in part on the first and second windowed images using an encoder comprising a neural network;
determining differences between in the first and second seismic images based at least in part on the embeddings;
generating similarity tiles representing at least some of the differences;
generating output seismic images by interpolating the similarity tiles using a decoder comprising a neural network; and
displaying perceptual differences in the first and second seismic images generated based at least in part on the output seismic images.

2. The method of claim 1, wherein the first seismic image and the second seismic image both represent a particular subsurface region, wherein the first seismic image represents the subsurface region before an interpretation process is applied, and wherein the second seismic image represents the subsurface region after the interpretation process is applied.

3. The method of claim 2, wherein the interpretation process comprises noise attenuation, a velocity model change, or both.

4. The method of claim 1, wherein the differences determined between the first and second seismic images based at least in part on the embeddings are localized so as to represent a portion of a subsurface region, and wherein the first and second seismic images both represent the subsurface region.

5. The method of claim 1, wherein the perceptual differences represent a magnitude and a direction of the perceptual differences between the first and second seismic images differences.

6. The method of claim 1, wherein the first and second seismic images are both three-dimensional seismic cubes, wherein the method further comprises generating two-dimensional slices in each of the first and second images, and wherein the first windowed image and the second windowed image are each partitioned from two-dimensional slices of the first and second images, respectively.

7. The method of claim 6, wherein generating the output seismic image comprises interpolating a plurality of the two-dimensional slices into a three-dimensional image.

8. A computing system, comprising:
one or more processors; and
a memory system comprising one or more non-transitory computer-readable media storing instructions that, when executed by at least one of the one or more processors, cause the computing system to perform operations, the operations comprising:
receiving a first seismic image representing a subsurface region;
generating a second seismic image by applying an interpretation process to the first seismic image;
partitioning the first seismic image to form a first patch, and the second seismic image for form a second patch;
generating embeddings based at least in part on the first and second patches using an encoder comprising a neural network;
determining differences between in the first and second seismic images based at least in part on the embeddings;
generating similarity tiles representing at least some of the differences;
generating output seismic images by interpolating the similarity tiles using a decoder comprising a neural network; and
displaying perceptual differences in the first and second seismic images generated based at least in part on the output seismic images.

9. The computing system of claim 8, wherein the interpretation process comprises noise attenuation, a velocity model change, or both.

10. The computing system of claim 8, wherein the differences determined between the first and second seismic images based at least in part on the embeddings are localized so as to represent a portion of a subsurface region, and wherein the first and second seismic images both represent the subsurface region.

11. The computing system of claim 8, wherein the perceptual differences represent a magnitude and a direction of the perceptual differences between the first and second seismic images differences.

12. The computing system of claim 8, wherein the first and second seismic images are both three-dimensional seismic cubes, wherein the method further comprises generating two-dimensional slices in each of the first and second images, and wherein the first patch and the second patch are each partitioned from the two-dimensional slices of the first and second images, respectively.

13. The computing system of claim 12, wherein generating the output seismic image comprises interpolating a plurality of the two-dimensional slices into a three-dimensional image.

14. A non-transitory computer-readable medium storing instructions that, when executed by one or more processors of a computing system, cause the computing system to perform operations, the operations comprising:
receiving a first seismic image and a second seismic image, the first and second seismic images representing a same subsurface region;
selecting a first two-dimensional cross-section from the first seismic image, and a second two-dimensional cross-section from the second seismic images;
partitioning the first and second two dimensional cross-sections into a first windowed image and a second windowed image, respectively;
generating embeddings based at least in part on the first and second windowed images using an encoder comprising a neural network, wherein the neural network is trained for one or more two-dimensional slices of seismic images;
determining differences between in the first and second seismic images based at least in part on the embeddings;
generating similarity tiles representing at least some of the differences;
generating output seismic images by interpolating the similarity tiles using a decoder; and
displaying perceptual differences in the first and second seismic images generated based at least in part on the output seismic images.

15. The medium of claim 14, wherein the first seismic image represents the subsurface region before an interpretation process is applied, and wherein the second seismic image represents the subsurface region after the interpretation process is applied.

16. The medium of claim 15, wherein the interpretation process comprises noise attenuation, a velocity model change, or both.

17. The medium of claim 14, wherein the differences determined between the first and second seismic images based at least in part on the embeddings are localized so as to represent a portion of a subsurface region, and wherein the first and second seismic images both represent the subsurface region.

18. The medium of claim 14, wherein the perceptual differences represent a magnitude and a direction of the perceptual differences between the first and second seismic images differences.

19. The medium of claim 18, wherein generating the output seismic image comprises interpolating a plurality of the two-dimensional slices into a three-dimensional image.

20. The medium of claim 14, wherein the first seismic image and the second seismic image represent the same subsurface region at different times.
